(19) United States
(12) Patent Application Publication
(10) Pub. No.: US 2020/0321812 A1
(43) Pub. Date: Oct. 8, 2020

(54) ALIGNMENT TOOL

(71) Applicant: Evutec Corp, Chino, CA (US)

(72) Inventors: Shawn Pasternak, Long Beach, CA (US); Lorraine Cabana, West Covina, CA (US)

(73) Assignee: Evutec Corp

(21) Appl. No.: 16/838,885

(22) Filed: Apr. 2, 2020

Related U.S. Application Data
(63) Continuation of application No. 62/828,023, filed on Apr. 2, 2019.

(51) Int. Cl. H02J 50/90; H02J 7/02; H02J 50/10

(52) U.S. Cl. CPC H02J 50/90; H02J 50/10; H02J 7/02

(57) ABSTRACT

An alignment tool has: an alignment plate; an aligner having a planar configuration configured to be placed on top of the alignment plate; and a universal sticker or under case ring having a tacky upper surface configured for connection to a lower surface of a mobile device. The aligner has a thickness that is greater than the universal sticker or under case ring. The aligner bottom surface of the aligner adheres to the alignment plate and has frictional contact with the alignment plate so that the alignment plate does not slip relative to the aligner bottom surface. After attachment of the ferrous plate an accessory can be removably connected so that the mobile device can be in a charging mode or accessory mode.

### ALIGNMENT TOOL

This application Alignment Tool by applicant and owner Evutec Corp, claims priority from U.S. provisional patent application number 62/828,023 filed Apr. 2, 2019 entitled Magnetic Adapter Alignment Tool, the disclosure of which is incorporated herein by reference.

### FIELD OF THE INVENTION

The present invention is in the field of magnetic adapter alignment tools for inductive wireless charging.

### DISCUSSION OF RELATED ART

In order for inductive wireless charging to work, both the transmitter coil and the receiver coil need to be closely aligned. In addition, any metal objects in the magnetic field of these coils may interfere with inductive wireless charging. In addition, the use of magnets to mount mobile devices has become common. However, applying the needed metal plates or magnets to mobile devices in such a way as to avoid interfering with inductive wireless charging is difficult. What is needed is a novel way of applying magnets or metal pieces to mobile devices and locating them to allow optimal alignment of the transmitter and receiver coils and to avoid locating the metal pieces or magnets where they could interfere with inductive wireless charging. With wireless receiver coils being located in the center of the majority of mobile devices, the focus is to center the metal pieces or magnets on the mobile device. By using stickers or rings with magnets or metal that have adhesive on one side it is easy to attach or remove a variety of different mounts, cradle, chargers or other accessories from mobile devices.

### SUMMARY OF THE INVENTION

The key to the invention is the addition of an easy to use alignment tool so that items stuck to the bottom surface of a cell phone or cell phone case are not misaligned. An alignment tool has: an alignment plate; an aligner having a planar configuration configured to be placed on top of the alignment plate; and a universal sticker or under case ring having a tacky upper surface configured for connection to a lower surface of a mobile device. The aligner has a thickness that is greater than the universal sticker or under case ring. The aligner bottom surface of the aligner adheres to the alignment plate and has frictional contact with the alignment plate so that the alignment plate does not slip relative to the aligner bottom surface. After attachment of the ferrous plate an accessory can be removably connected so that the mobile device can be in a charging mode or accessory mode.

### BRIEF DESCRIPTION OF THE DRAWINGS

FIG. 1 is an exploded view drawing showing parts assembly.

FIG. 2 is a perspective view diagram showing use of the alignment tool.

FIG. 3 is a perspective view diagram showing use of the alignment tool.

FIG. 4 is an exploded view diagram of an accessory attaching to the mobile device in an accessory mode.

FIG. 5 is a diagram of the mobile device in a charging mode when placed on a mobile device with the accessory absent.

The following call out list of elements can be a useful guide in referencing the element numbers of the drawings.

10 mobile device

11 mobile device top surface

12 mobile device bottom surface

13 mobile device side surface

14 mobile device charging station

15 inductive charging coil

16 battery

21 foam sheet releasable tacky underside

22 foam sheet thickness

23 nonferrous middle portion

24 adhesive contact upward facing surface

25 magnetic adapter alignment tool upper side

26 mobile device placement indicia

31 first strip of ferrous material

32 second strip of ferrous material

33 third strip of ferrous material

34 fourth strip of ferrous material

35 fifth strip of ferrous material

41 inside edge of aligner

42 outside edge of universal sticker under case ring

50 accessory

51 handle

52 magnetic accessory base

53 swivel enabled handle base

101 magnetic adapter alignment tool

102 alignment plate

103 universal sticker

104 under case ring

105 aligner

106 mobile device first type

107 first type grid of alignment plate

108 aligner bottom surface

109 first type adhesive upper surface of under case ring

110 mobile device second type

111 second type grid of alignment plate

112 second type adhesive upper surface of under case ring

113 second type adhesive upper surface of universal sticker

### DESCRIPTION OF INVENTION

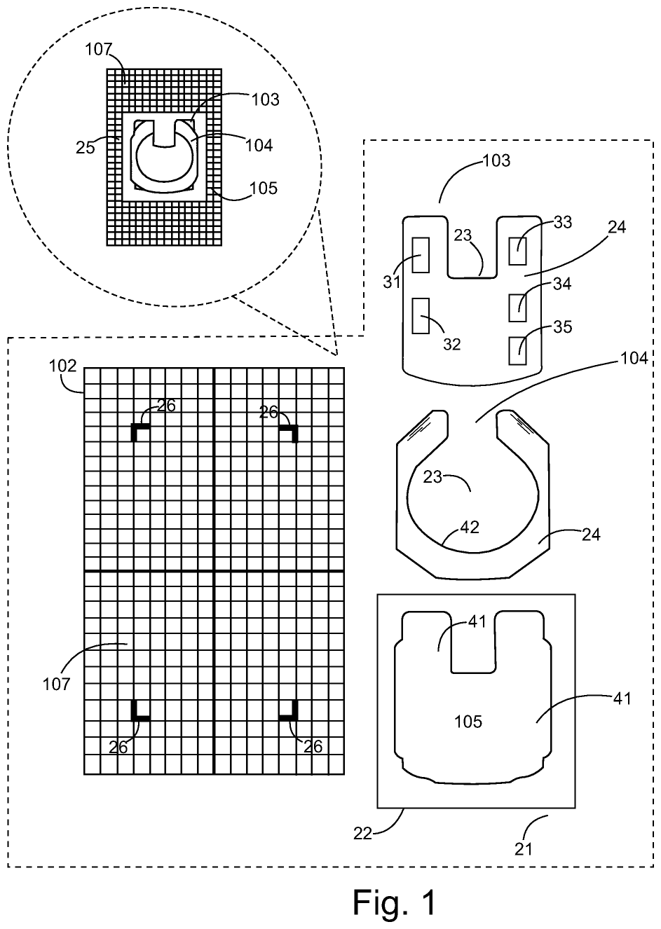

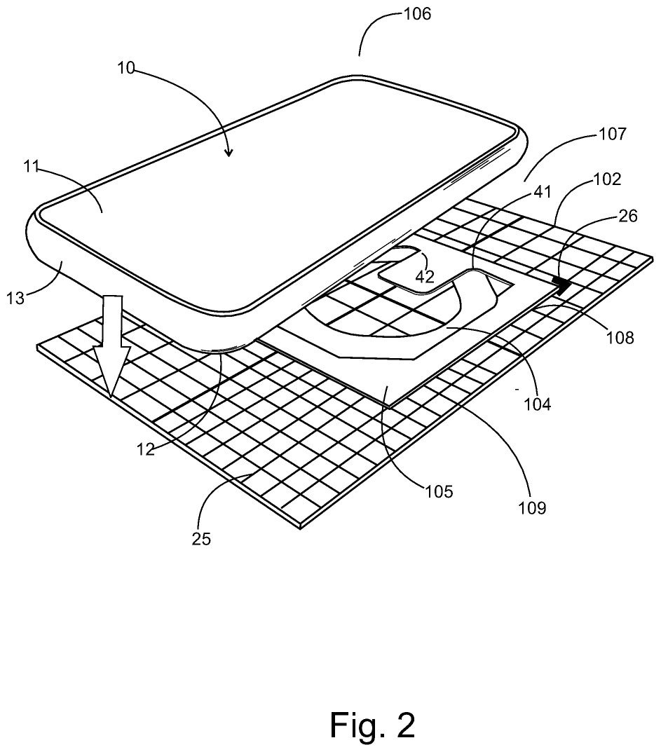

As seen in FIGS. 1-2, the purpose of the present invention is to align and adhere a magnetic sticker to a mobile device bottom surface 12 of a mobile device 10. The mobile device also has a mobile device side surface 13 and a mobile device top surface 11. A magnetic adapter alignment tool 101 adheres a universal sticker 103 or an under case ring 104 to an underside of a cell phone 10.

As seen in FIG. 1, the key components of the magnetic adapter alignment tool 101 include the universal sticker 103 and the under case ring 104. The diagram shows universal sticker placed underneath the under case ring 104, however this diagram is only for purposes of showing placement. It actual use, only the universal sticker 103 or the under case ring 104 would be deployed.

The magnetic adapter alignment tool 101 has an alignment plate 102 which acts as a substrate and foundation. The alignment plate 102 can be a temporary sticker that sticks to a flat surface such as a tabletop or countertop. The alignment plate 102 allows a user to center the cell phone so that the inductive coil of the cell phone is optimally aligned with the inductive coil of the inductive charger base device. The alignment plate 102 also provides a grid 107 showing alignment indicia for providing an aesthetically appealing alignment that optimizes inductive charging efficiency. The alignment plate is a rigid plate such as a card stock, a plastic high density polyethylene plate or a metal sheet or plate. The alignment plate 102 has a grid of the alignment plate 107 that can be imprinted by screen-printing, etching or the like. The alignment plate 102 can be flexible to provide a flexible alignment plate that can conform to a lower surface of the cell phone. The alignment plate 102 can have a markable surface so that the user can trace an outline of the mobile device onto the alignment plate 102 should the user desire to verify placement before adhering an external object to their beloved cell phone.

The foam sheet 105 placed on the alignment plate 102. The foam sheet 105 can also be a sticker that has a foam sheet releasable tacky underside 21. The foam sheet 105 also has a foam sheet thickness 22 which can be between about 0.15 mm and 1.5 mm in thickness in the case of a universal sticker 103 that has a small thickness and can be between about 1 mm and 5 mm in the case of an under case ring 104 if the under case ring has greater thickness than the universal sticker 103.

The universal sticker 103 and the under case ring 104 have a nonferrous middle portion 23 that does not block inductive charging and does not contain metal or ferrous material. The universal sticker 103 and the under case ring 104 have an adhesive contact upward facing surface 24. The universal sticker 103 can be made of plastic having a number of metal components laminated to the plastic sticker. For example, five strips of ferrous material can be stuck to a vinyl sticker including a first strip of ferrous material 31, a second strip of ferrous material 32, a third strip of ferrous material 33, a fourth strip of ferrous material 34, and a fifth strip of ferrous material 35.

As seen in FIG. 2, the magnetic adapter alignment tool 101 can be used as a tool for mounting an under case ring 104 to a mobile device 10 such as a mobile device first type 106 using an alignment plate 102 having a first type grid of the alignment plate 107. The aligner bottom surface 108 of the aligner 105 adheres to the alignment plate 102 has frictional contact with the alignment plate 102 so that the alignment plate 102 does not slip relative to the aligner bottom surface 108.

The magnetic adapter alignment tool 101 has a magnetic adapter alignment tool upper side 25 and is generally flat. The first type grid of the alignment plate 107 can be supplemented with coordinate markings for indication of placement of the aligner 105, to provide suggested indicia for a particular phone model for example. Furthermore, mobile device placement indicia 26 can be formed on the grid of the alignment plate. A user can further align the grid of the alignment plate 107 with an edge of the mobile device which provides additional confirmation to the user that the item to be stuck to the mobile device is aligned.

The first type adhesive upper surface of the under case ring 109 adheres to the mobile device bottom surface 12.

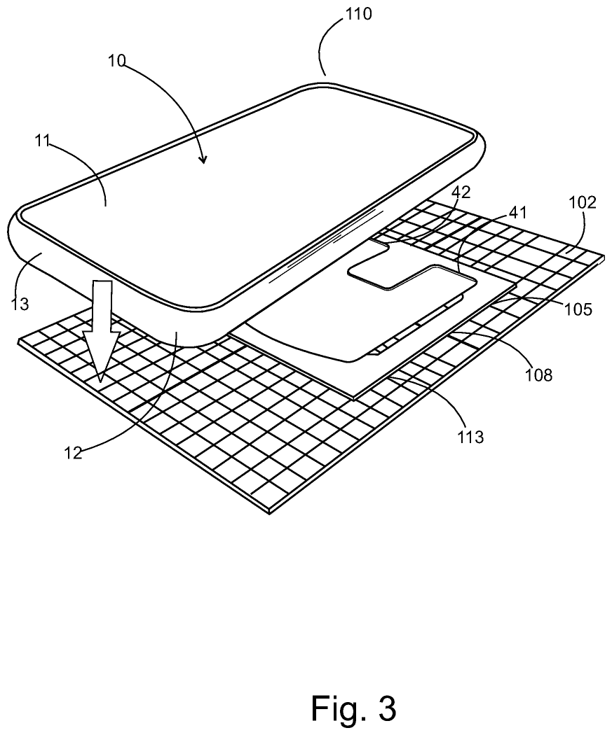

As seen in FIG. 3, the mobile device second type 110 can fit on a second type of grid alignment plate 111 marked on the alignment plate 102. The aligner 105 has an aligner bottom surface adhered 108 to the alignment plate. The second type adhesive upper surface of the universal sticker 313 sticks to the mobile device bottom surface 12.

The markings can be in the configuration of a grid. The alignment plate is facing up. The mobile device has a lower surface that faces the upper surface of the alignment plate. The lower surface of the mobile device can receive a universal sticker 103. The universal sticker 103 has a U-shaped profile that is similar to a U-shaped profile of the under case ring 104.

The magnetic adapter alignment tool has an aligner 105 that is preferably centered to the center of the alignment marks on the alignment plate as shown in the figures. The aligner is configured to hold the universal sticker for the under case ring. The universal sticker and the under case ring are both made of ferrous metal for magnetic attraction and magnetic alignment to an accessory. Preferably, discrete magnets held in the under case ring for the universal sticker are aligned to an accessory such as a charging stand base, a mobile device handle, or a goose neck stand or other mobile device mount. The discrete magnets adhered to the accessory can attract to the discrete magnets on the mobile device.

Accordingly, the aligner 105 is preferably made of a foam sheet having a foam sheet releasable tacky underside 21 and a foam sheet thickness 22. The aligner thickness can be constructed so as to be higher than the universal sticker or under case ring. The aligner is preferably made of a compressible compliant material that can compress under pressure such as when a user presses down on it. A user first outlines the magnetic adapter alignment tool and selects either the universal sticker 103 or the under case ring 104 and then the user pushes down on the mobile device 10 so that the adhesive contact upward facing surface of the universal sticker or the under case ring makes connection to the mobile device bottom surface 12. The mobile device bottom surface 12 can be a lower surface of a cell phone for a lower surface of a removable cell phone case. The cell phone type can be the mobile device first type 106, and the removable cell phone case can be the mobile device second type 110.

The universal sticker 103 and the under case ring 104 have adhesive located on only the top side facing the mobile device. To align the universal sticker or under case ring, the universal sticker or under case ring is placed in the aligner with the adhesive facing up. Preferably, an inside edge of the aligner 41 engages with an outside edge of the universal sticker or under case ring 42. The engagement can be an abutment of a side wall thickness of the foam sheet of the aligner 105 to a sidewall of the universal sticker or under case ring.

As seen in FIGS. 2, 3, the connection allows the mobile device to be well aligned when placed on top of the aligner. Because the aligner has a greater height than the universal sticker or under case ring, the tacky upper surface of the universal sticker or the under case ring is not in contact with the bottom surface of the mobile device. Thus, the mobile device can be easily moved by translation and sliding into a precise location so that it is centered with the magnetic adapter alignment tool. Then by pressing down on the mobile device, the aligner is compressed such that the bottom surface of the mobile device can contact the adhesive of the universal sticker or under case ring. The adhesive bonds the universal sticker or under case ring to the mobile device at which time the mobile device can be removed from the magnetic adapter alignment tool. This alignment tool is preferably simple and low-cost. Although there are other possible ways to construct a low-cost alignment tool, this embodiment is believed to be the best mode. Optionally, the universal sticker has a thickness that provides an outside sidewall edge for engaging an inside sidewall edge of the aligner. The aligner is preferably twice as thick as the universal sticker or under case ring. The aligner has a top surface that is higher than the level of a top surface of the universal sticker, and is higher than a top surface of the under case ring.

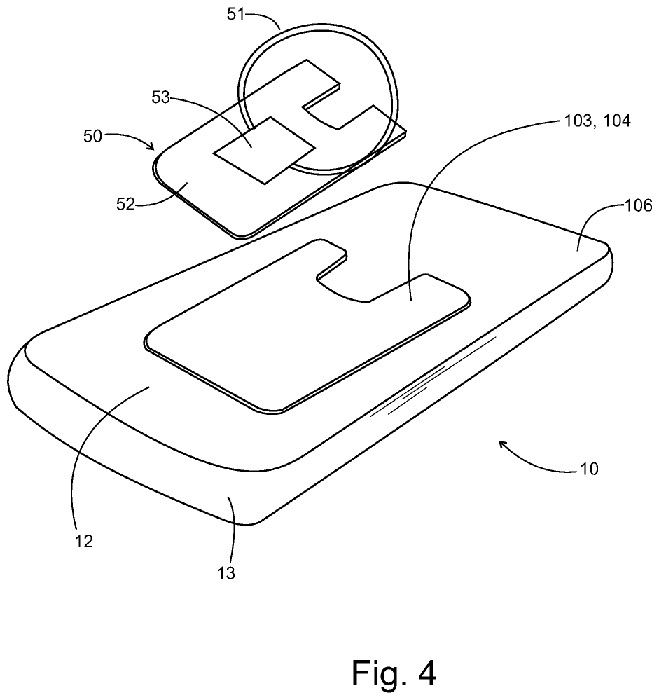

As seen in FIG. 4, an accessory 50 can magnetically attach to the universal sticker 103 or the under case ring 104. The accessory 50 can have a handle 51 for use as a stand or for holding the mobile device 10. The handle 51 can be mounted to a swivel enabled handle base 53. The handle base 53 is mounted to the magnetic accessory base 52. The accessory 50 is magnetically releasably detachable from the mobile device 10. The accessory 50 fits onto the mobile device 10 in an accessory mode. To switch from accessory mode to the charging mode, the user detaches the accessory 50 from the mobile device 10. The accessory 50 could be a gooseneck stand, a car suction cup stand, or the like.

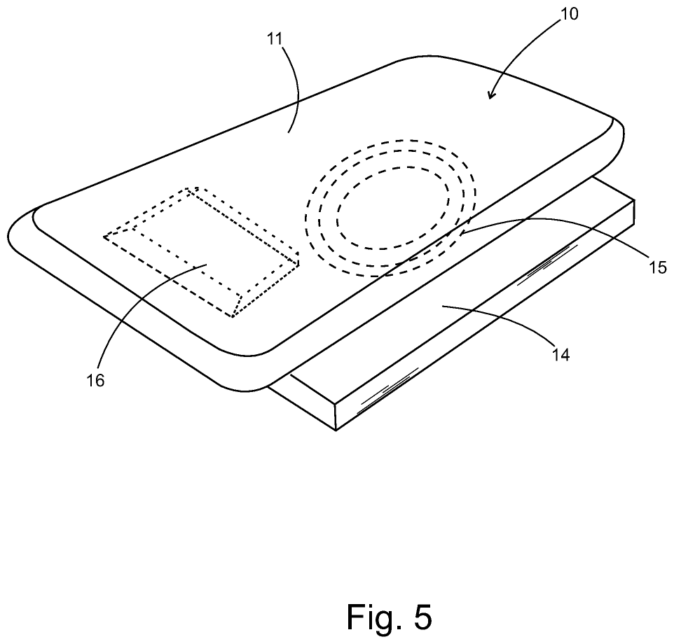

As in FIG. 5, an accessory can be removed magnetically so that the mobile device 10 can be in a charging mode. The mobile device 10 can be placed on a charging base of a mobile device charging station 14. The charging base optionally includes alignment magnets that can align the mobile device 10 for optimum charging. The mobile device charging station 14 has an inductive charging coil 15 which electromagnetically engages the inductive charging coil inside the mobile device for charging a battery 16 of the mobile device.

1. An alignment tool comprising:
a. an alignment plate;
b. an aligner having a planar configuration configured to be placed on top of the alignment plate; and
c. a ferrous plate formed as either a universal sticker or under case ring, wherein the ferrous plate has a tacky upper surface configured for connection to a lower surface of a mobile device.

2. The alignment tool of claim 1, wherein the aligner has a thickness that is greater than the universal sticker or under case ring.

3. The alignment tool of claim 1, wherein the aligner bottom surface of the aligner adheres to the alignment plate and has frictional contact with the alignment plate so that the alignment plate does not slip relative to the aligner bottom surface.
